(19) United States
(12) Patent Application Publication
(10) Pub. No.: US 2026/0148709 A1
(43) Pub. Date: May 28, 2026

(54) DISPLAY DEVICE, OPERATING METHOD OF DISPLAY DEVICE AND RECORDING MEDIUM

(71) Applicant: LG ELECTRONICS INC., Seoul (KR)

(72) Inventors: Chanho LEE, Seoul (KR); Hyojae SHIN, Seoul (KR)

(73) Assignee: LG ELECTRONICS INC., Seoul (KR)

(21) Appl. No.: 19/397,537

(22) Filed: Nov. 21, 2025

(30) Foreign Application Priority Data
Nov. 22, 2024 (KR) 10-2024-0168216

(51) Int. Cl. G09G 3/34

(52) U.S. Cl. CPC G09G 3/3413; G09G 3/3426; G09G 2320/0233; G09G 2320/0238; G09G 2360/16

(57) ABSTRACT

A display device according to an embodiment of the present disclosure may comprise a display panel; a backlight including a plurality of light sources that provide light to the display panel; and a controller configured to: obtain a illuminance and image information of an input image, increase a tone intensity of a low gray-level area of the input image based on the image information when the illuminance is less than a reference value, and control the backlight so that a current flowing in light sources corresponding to the low gray-level area is reduced.

### CROSS-REFERENCE TO RELATED APPLICATION

Pursuant to 35 U.S.C. § 119(a), this application claims the benefit of earlier filing date and right of priority to Korean Patent Application No. 10-2024-0168216, filed on Nov. 22, 2024, the contents of which are all incorporated by reference herein in its entirety.

### BACKGROUND OF THE INVENTION

### 1. Field of the Invention

This disclosure relates to a display device, and more specifically, to a display device for improving the image quality of an input image.

### 2. Discussion of the Related Art

Liquid crystal displays (LCDs) may be miniaturized compared to cathode ray tubes (CRTs), so they are used in display devices such as portable information devices, office equipment, and computers.

Transmissive display, which make up the majority of liquid crystal display, display image by controlling the electric field applied to the liquid crystal layer and modulating light incident from the backlight.

Tone mapping is a technology that adjusts the brightness and color of HDR (High Dynamic Range) images to suit general display device. The tone mapping is a method of compressing the wide brightness range of an HDR image to the range that a general display device may express, thereby reproducing contrast ratio and color as natural and close to the original image as possible.

Conventionally, there was a method of processing tone mapping based on the histogram distribution of input HDR image data. However, although luminance amplification for the entire area of HDR image data is possible, there are limitations in processing to distinguish gray-level range and image information.

Another prior art was a tone mapping method to increase gradation expression according to the brightness information recognized by the illuminance sensor. However, this method had the problem of being less effective in improving expression and detail for image with a high degree of saturation.

### SUMMARY OF THE INVENTION

The purpose of the present disclosure may be to improve the expressiveness and black visibility of low gray-level area of HDR images.

The purpose of the present disclosure may be to provide improved HDR image quality by overcoming limitations due to the characteristics of backlight LEDs, which have a lower contrast ratio compared to OLED (Organic Light Emitting Diode).

The purpose of the present disclosure may be to improve black visibility by applying dimming according to the degree of tone enhancement.

A display device according to an embodiment of the present disclosure may comprise A display device according to an embodiment of the present disclosure may comprise a display panel; a backlight including a plurality of light sources that provide light to the display panel; and a controller configured to: obtain a illuminance and image information of an input image, increase a tone intensity of a low gray-level area of the input image based on the image information when the illuminance is less than a reference value, and control the backlight so that a current flowing in light sources corresponding to the low gray-level area is reduced.

A method of operating a display device according to an embodiment of the present disclosure may comprise obtaining a illuminance and image information of an input image; increasing a tone intensity of a low gray-level area of the input image based on the image information when the illuminance is less than a reference value; and controlling the backlight so that a current flowing in light sources corresponding to the low gray-level area is reduced

A non-transitory computer-readable recording medium on which a program for performing a method of operating a display device is recorded wherein the method may comprise: obtaining a illuminance and image information of an input image; increasing a tone intensity of a low gray-level area of the input image based on the image information when the illuminance is less than a reference value; and controlling the backlight so that a current flowing in light sources corresponding to the low gray-level area is reduced.

According to an embodiment of the present disclosure, the gray-level expressiveness of the image may be improved by adaptively strengthening tone mapping processing for the low gray-level area of the HDR image according to the illuminance sensor.

According to an embodiment of the present disclosure, the expressiveness of the image in the low gray-level area of the HDR image may be improved as the tone of each local area of the low gray-level area is locally adjusted.

According to an embodiment of the present disclosure, black visibility may be improved by applying dimming according to the degree of tone enhancement.

### BRIEF DESCRIPTION OF THE DRAWINGS

FIG. 1 is a diagram illustrating a display device according to an embodiment of the present invention.

FIG. 2 is an example of a block diagram of the inside of the display device in FIG. 1.

FIG. 3 is an example of a block diagram of the inside of a controller in FIG. 2.

FIG. 4 is a block diagram of the inside of the display.

FIG. 5 is an example showing arrangement of a liquid crystal display panel and light sources in a direct-type backlight.

FIG. 6 is an example showing arrangement of a liquid crystal display panel and light sources in an edge type backlight.

FIG. 7 is an example of a light source driving circuit according to an embodiment of the present disclosure.

FIG. 8 is a flowchart for explaining a method of operating a display device according to an embodiment of the present disclosure.

FIG. 9 is a diagram illustrating an example of increasing the slope of the tone mapping curve corresponding to the low gray-level area based on the illuminance being more than or equal to the reference value according to an embodiment of the present disclosure.

FIGS. 10A and 10B are diagrams illustrating an example of increasing the slope of a tone mapping curve corresponding to a low gray-level area based on the illuminance being less than a reference value according to an embodiment of the present disclosure.

FIGS. 11A and 11B are diagrams illustrating a process of applying dimming after performing tone mapping on a low gray-level area when the illuminance value is less than a reference value according to an embodiment of the present disclosure.

FIGS. 12 and 13 are diagrams comparing before and after applying tone enhancement and dimming to a low gray-level area of an HDR image according to an embodiment of the present disclosure.

FIGS. 14 and 15 are diagrams illustrating a method for determining whether an embodiment of the present disclosure is applicable.

### DETAILED DESCRIPTION OF THE PREFERRED EMBODIMENTS

Hereinafter, the present specification will be described in more detail with reference to the drawings.

The suffixes “module” and “part” used in the following description are assigned purely for the convenience of drafting this specification and do not inherently impart any special significance or role. Therefore, the terms “module” and “part” may be used interchangeably with each other.

Terms containing ordinal numbers, such as first, second, etc, may be used to describe various components, but the components are not limited by the terms. The above terms are used only for the purpose of distinguishing one component from another.

Singular expression includes plural expressions unless the context clearly dictates otherwise.

In this application, terms such as “comprise” or “have” are intended to designate the presence of features, numbers, steps, operations, components, parts, or combinations thereof described in the specification, but are not intended to indicate the presence of one or more other features and it should be understood that this does not exclude in advance the possibility of the existence or addition of elements, numbers, steps, operations, components, parts, or combinations thereof.

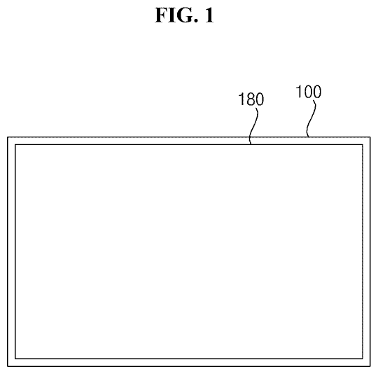

FIG. 1 is a diagram illustrating a display device according to an embodiment of the present disclosure.

The display device 100 may include a display 180.

The display (180) may be implemented as either a Liquid Crystal Display (LCD) panel or an Organic Light Emitting Diode (OLED) panel.

Meanwhile, the display device 100 of FIG. 1 may be a monitor, TV, tablet PC, mobile terminal, etc.

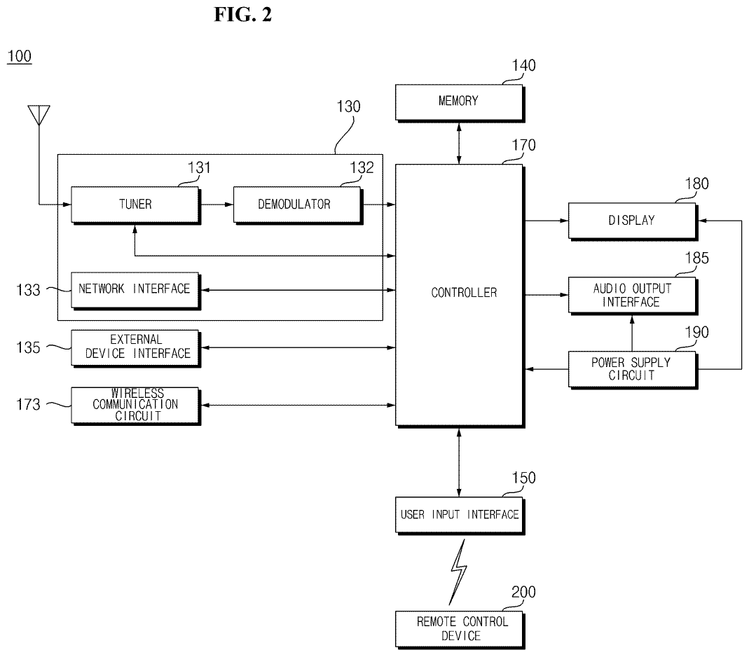

FIG. 2 is a block diagram showing the configuration of the display device of FIG. 1.

Referring to FIG. 2, the display device 100 may include an image receiver 130, an external device interface 135, a memory 140, a user input interface 150, a controller 170, and a wireless communication circuit 173, a display 180, an audio output interface 185, and a power supply circuit 190.

The image receiver 130 may include a tuner 131, a demodulator 132, and a network interface 133.

The tuner 131 may select a specific broadcast channel according to a channel selection command. The tuner 131 may receive a broadcast signal for a specific selected broadcast channel.

The demodulator 132 may separate the received broadcast signal into a video signal, an audio signal, and a data signal related to the broadcast program, and may restore the separated video signal, audio signal, and data signal to a form that may be output.

The external device interface 135 may receive an application or application list in an adjacent external device and transmit it to the controller 170 or the memory 140.

The external device interface 135 may provide a connection path between the display device 100 and an external device. The external device interface 135 may receive one or more of video and audio output from an external device connected wirelessly or wired to the display device 100 and transmit it to the controller 170. The external device interface 135 may include a plurality of external input terminals. The plurality of external input terminals may include an RGB terminal, one or more High Definition Multimedia Interface (HDMI) terminals, and a component terminal.

An image signal from an external device input through the external device interface 135 may be output through the display 180. A audio signal from an external device input through the external device interface 135 may be output through the audio output interface 185.

An external device that may be connected to the external device interface 135 may be any one of a set-top box, Blu-ray player, DVD player, game console, sound bar, smartphone, PC, USB memory, or home theater, but this is only an example.

The network interface 133 may provide an interface for connecting the display device 100 to a wired/wireless network including an Internet network. The network interface 133 may transmit or receive data to or from other users or other electronic devices through a connected network or another network linked to the connected network.

In addition, a part of content data stored in the display device 100 may be transmitted to a selected user among a selected user or a selected electronic device among other users or other electronic devices registered in advance in the display device 100.

The network interface 133 may access a predetermined web page through the connected network or the other network linked to the connected network. That is, it is possible to access a predetermined web page through a network, and transmit or receive data to or from a corresponding server.

In addition, the network interface 133 may receive content or data provided by a content provider or a network operator. That is, the network interface 133 may receive content such as movies, advertisements, games, VOD, and broadcast signals and information related thereto provided from a content provider or a network provider through a network.

In addition, the network interface 133 may receive update information and update files of firmware provided by the network operator, and may transmit data to an Internet or content provider or a network operator.

The network interface 133 may select and receive a desired application from among applications that are open to the public through a network.

The memory 140 stores program for processing and controlling each signal in the controller 170, and may store signal-processed video, audio, or data signal.

The memory 140 may perform a function for temporarily storing video, voice, or data signal input from the external device interface 135 or the network interface 133, and may store information about a predetermined image through a channel memory function.

The memory 140 may store an application or a list of applications input from the external device interface 135 or the network interface 133.

The display device 100 may play back a content file (a moving image file, a still image file, a music file, a document file, an application file, or the like) stored in the memory 140 and provide the same to the user.

The user input interface 150 may transmit a signal input by the user to the controller 170 or a signal from the controller 170 to the user. For example, the user input interface 150 may receive and process a control signal such as power on/off, channel selection, screen settings, and the like from the remote control device 200 in accordance with various communication methods, such as a Bluetooth communication method, a WB (Ultra Wideband) communication method, a ZigBee communication method, an RF (Radio Frequency) communication method, or an infrared (IR) communication method or may perform processing to transmit the control signal from the controller 170 to the remote control device 200.

In addition, the user input interface 150 may transmit a control signal input from a local key (not shown) such as a power key, a channel key, a volume key, and a setting value to the controller 170.

The image signal image-processed by the controller 170 may be input to the display 180 and displayed as an image corresponding to a corresponding image signal. Also, the image signal image-processed by the controller 170 may be input to an external output device through the external device interface 135.

The audio signal processed by the controller 170 may be output to the speaker 185. Also, the audio signal processed by the controller 170 may be input to the external output device through the external device interface 135.

In addition, the controller 170 may control the overall operation of the display device 100.

In addition, the controller 170 may control the display device 100 by a user command input through the user input interface 150 or an internal program and connect to a network to download an application a list of applications or applications desired by the user to the display device 100.

The controller 170 may allow the channel information or the like selected by the user to be output through the display 180 or the speaker 185 along with the processed image or audio signal.

In addition, the controller 170 may output an image signal or an audio signal through the display 180 or the speaker 185, according to a command for playing back an image of an external device through the user input interface 150, the image signal or the audio signal being input from an external device, for example, a camera or a camcorder, through the external device interface 135.

Meanwhile, the controller 170 may allow the display 180 to display an image, for example, allow a broadcast image which is input through the tuner 131 or an external input image which is input through the external device interface 135, an image which is input through the network interface unit or an image which is stored in the memory 140 to be displayed on the display 180. In this case, an image being displayed on the display 180 may be a still image or a moving image, and may be a 2D image or a 3D image.

In addition, the controller 170 may allow content stored in the display device 100, received broadcast content, or external input content input from the outside to be played back, and the content may have various forms such as a broadcast image, an external input image, an audio file, still images, accessed web screens, and document files.

The wireless communication interface 173 may communicate with an external device through wired or wireless communication. The wireless communication interface 173 may perform short range communication with an external device. To this end, the wireless communication interface 173 may support short range communication using at least one of Bluetooth™, Radio Frequency Identification (RFID), Infrared Data Association (IrDA), Ultra Wideband (UWB), ZigBee, Near Field Communication (NFC), Wi-Fi (Wireless-Fidelity), Wi-Fi(Wireless-Fidelity), Wi-Fi Direct, and Wireless USB (Wireless Universal Serial Bus) technologies. The wireless communication interface 173 may support wireless communication between the display device 100 and a wireless communication system, between the display device 100 and another display device 100, or between the display device 100 and a network in which the display device 100 (or an external server) is located through wireless area networks. The wireless area networks may be wireless personal area networks.

Here, the another display device 100 may be a wearable device (e.g., a smartwatch, smart glasses or a head mounted display (HMD), a mobile terminal such as a smart phone, which is able to exchange data (or interwork) with the display device 100 according to the present disclosure. The wireless communication interface 173 may detect (or recognize) a wearable device capable of communication around the display device 100.

Furthermore, when the detected wearable device is an authenticated device to communicate with the display device 100 according to the present disclosure, the controller 170 may transmit at least a portion of data processed by the display device 100 to the wearable device through the wireless communication interface 173. Therefore, a user of the wearable device may use data processed by the display device 100 through the wearable device.

The display 180 may convert image signals, data signals, and OSD signals processed by the controller 170, or image signals or data signals received from the external device interface 135 into R, G, and B signals, and generate drive signals.

Meanwhile, since the display device 100 shown in FIG. 1 is only an embodiment of the present disclosure, some of the illustrated components may be integrated, added, or omitted depending on the specification of the display device 100 that is actually implemented.

That is, two or more components may be combined into one component, or one component may be divided into two or more components as necessary. In addition, a function performed in each block is for describing an embodiment of the present disclosure, and its specific operation or device does not limit the scope of the present disclosure.

According to another embodiment of the present disclosure, unlike the display device 100 shown in FIG. 1, the display device 100 may receive an image through the network interface 133 or the external device interface 135 without a tuner 131 and a demodulator 132 and play back the same.

For example, the display device 100 may be divided into an image processing device, such as a set-top box, for receiving broadcast signals or content according to various network services, and a content playback device that plays back content input from the image processing device.

In this case, an operation method of the display device according to an embodiment of the present disclosure will be described below may be implemented by not only the display device 100 as described with reference to FIG. 1 and but also one of an image processing device such as the separated set-top box and a content playback device including the display 180 and the speaker 185.

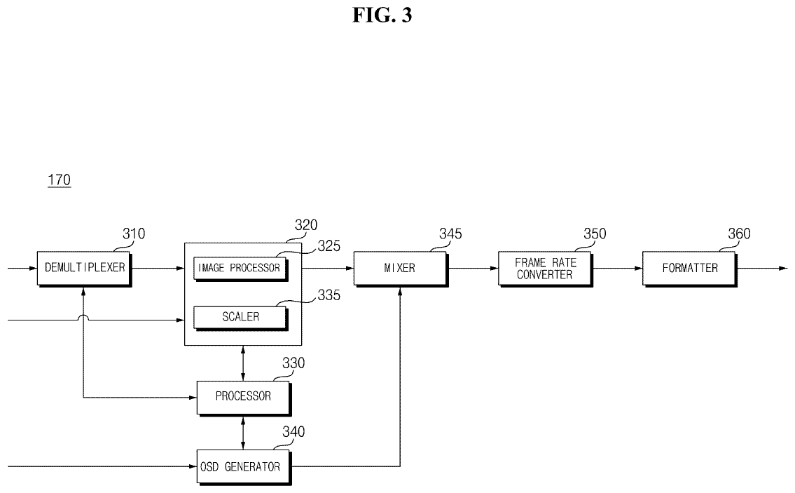

FIG. 3 is an example of an internal block diagram of the controller of FIG. 2.

When described with reference to the drawing, the controller 170 according to an embodiment of the present disclosure may include a demultiplexer 310, an image processor 320, a processor 330, an OSD generator 340, and a mixer 345, a frame rate converter 350, and a formatter 360.

the controller 170 may further include an audio processor (not shown) and a data processor (not shown).

The demultiplexer 310 demultiplexes the input stream. For example, when MPEG-2 TS is input, it may be demultiplexed and separated into video, voice, and data signals. Here, the stream signal input to the demultiplexer 310 may be a stream signal output from the tuner 110, the demodulator 120, or the external device interface 130.

The image processor 320 may perform image processing of demultiplexed video signal. For this purpose, the image processor 320 may include an video decoder 325 and a scaler 335.

The video decoder 325 decodes the demultiplexed video signal, and the scaler 335 performs scaling so that the resolution of the decoded video signal may be output on the display 180.

The video decoder 325 may be equipped with decoder of various standards. For example, an MPEG-2, H, 264 decoder, a 3D video decoder for color image and depth image, a decoder for multiple viewpoint images, etc. may be provided.

The processor 330 may control overall operations within the display device 100 or the controller 170. For example, the processor 330 may control the tuner 110 to select (tuning) an RF broadcast corresponding to a channel selected by the user or a pre-stored channel.

Additionally, the processor 330 may control the display device 100 by a user command or internal program input through the user input interface 150.

Additionally, the processor 330 may perform data transmission control with the network interface 135 or the external device interface 130.

Additionally, the processor 330 may control the operations of the demultiplexer 310, the image processor 320, and the OSD generator 340 within the controller 170.

The OSD generator 340 generates an OSD signal according to user input or by itself. For example, based on a user input signal, a signal may be generated to display various information in graphic or text on the screen of the display 180. The generated OSD signal may include various data such as a user interface screen of the display device 100, various menu screen, widget, and icon. Additionally, the generated OSD signal may include 2D object or 3D object.

Additionally, the OSD generator 340 may generate a pointer that may be displayed on the display 180 based on the pointing signal input from the remote control device 200. In particular, such a pointer may be generated in a pointing signal processor, and the OSD generator 340 may include such a pointing signal processor (not shown). Of course, it is also possible that the pointing signal processor (not shown) is provided separately rather than within the OSD generator 340.

The mixer 345 may mix the OSD signal generated by the OSD generator 340 and the decoded video signal processed by the image processor 320. The mixed video signal is provided to the frame rate converter 350.

The frame rate converter (FRC) 350 may convert the frame rate of the input video. Meanwhile, the frame rate converter 350 is also capable of outputting the video as is without separate frame rate conversion.

Meanwhile, the formatter 360 may change the format of an input video signal into a video signal for display on a display and output it.

The formatter 360 may change the format of the video signal. For example, the format of the 3D video signal may be changed to any one of various 3D formats such as Side by Side format, Top/Down format, Frame Sequential format, Interlaced format, Checker Box format.

Meanwhile, the audio processor (not shown) in the controller 170 may perform audio processing of the demultiplexed audio signal. For this purpose, the audio processor (not shown) may be equipped with various decoders.

Additionally, the audio processor (not shown) within the controller 170 may process bass, treble, and volume control.

The data processor (not shown) within the controller 170 may perform data processing of the demultiplexed data signal. For example, if the demultiplexed data signal is an encoded data signal, it may be decoded. The encoded data signal may be electronic program guide information including broadcast information such as the start time and end time of the broadcast program aired on each channel.

Meanwhile, the block diagram of the controller 170 shown in FIG. 3 is a block diagram for an embodiment of the present disclosure. Each component of the block diagram may be integrated, added, or omitted depending on the specifications of the controller 170 that is actually implemented.

In particular, the frame rate converter 350 and the formatter 360 may not be provided within the controller 170, but may be provided separately or as a single module.

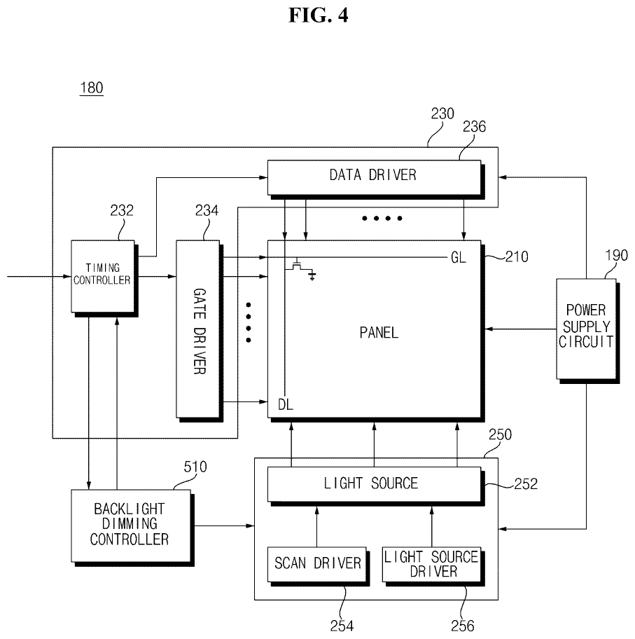

FIG. 4 is an internal block diagram of the display of FIG. 2.

Referring to the drawing, the display module 180 based on a liquid crystal display panel (LCD panel) may include a liquid crystal display panel 210, a driving circuit 230, a backlight 250, and a backlight dimming controller 510.

In order to display an image, a plurality of gate lines (GL) and data lines (DL) are intersected in a matrix form, and the liquid crystal display panel 210 may include a first substrate a thin film transistor and a pixel electrode connected to it are formed in the intersecting area, a second substrate provided with a common electrode, and a liquid crystal layer formed between the first substrate and the second substrate.

The driving circuit 230 drives the liquid crystal display panel 210 through control signal and data signal supplied from the controller 170 of FIG. 1. To this end, the driving circuit 230 includes a timing controller 232, a gate driver 234, and a data driver 236.

The timing controller 232 receives a control signal, R, G, B data signals, vertical synchronization signal (Vsync), etc. from the controller 170, and controls the gate driver 234 and the data driver 236 in response to the control signal and rearranges the R, G, and B data signals to provide to the data driver 236.

Under the control of the gate driver 234, data driver 236, and timing controller 232, scanning signal and image signal are supplied to the liquid crystal display panel 210 through the gate line (GL) and data line (DL).

The backlight 250 supplies light to the liquid crystal display panel 210. To this end, the backlight 250 may include a light source 252, a smay driver 254 that controls the scanning drive of the light source 252, and a light source driver 256 that turns on/off the light source 252.

With the light transmittance of the liquid crystal layer adjusted by the electric field formed between the pixel electrode and the common electrode of the liquid crystal display panel 210, a predetermined image is displayed using light emitted from the backlight 250.

The power supply circuit 190 may supply a common electrode voltage (Vcom) to the liquid crystal display panel 210 and a gamma voltage to the data driver 236. Additionally, driving power for driving the light source 252 may be supplied to the backlight 250.

Meanwhile, the backlight 250 may be divided into a plurality of blocks and driven. The controller 170 may control the display 180 to perform local dimming by setting a dimming value for each of the plurality of blocks.

Specifically, the timing controller 232 outputs input image data (RGB) to the backlight dimming controller 510, and the backlight dimming controller 510 may calculate the dimming value of each of the plurality of blocks based on the input image data (RGB) received from the timing controller 232.

The backlight dimming controller 510 may output dimming values to the backlight 250. The dimming value may include at least one of a duty ratio for driving each backlight block or an current magnitude ratio.

The backlight dimming controller 510 may be included in the controller 170.

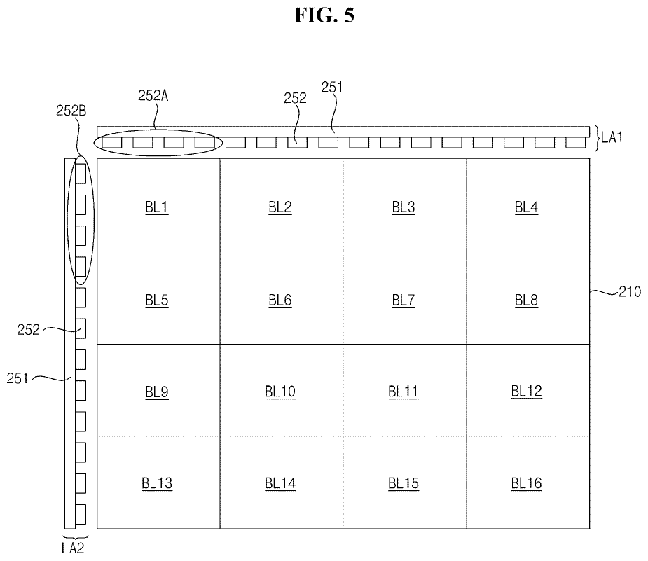

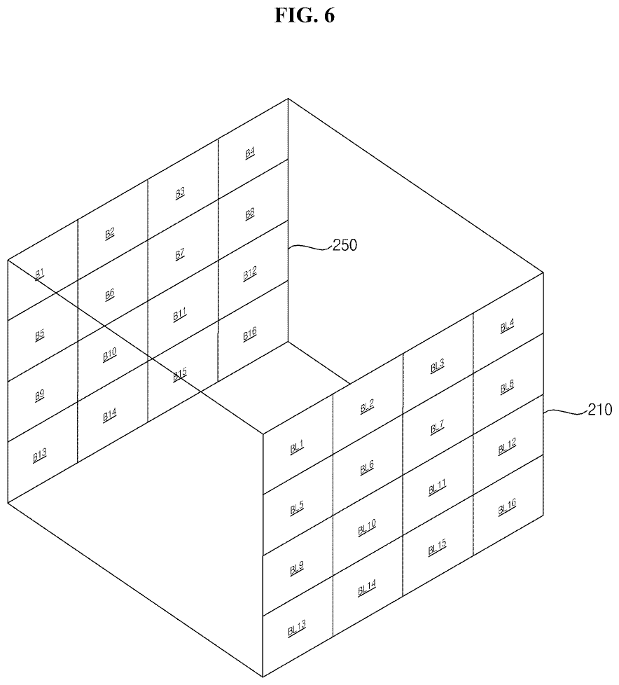

FIG. 5 is an example diagram showing the arrangement of a liquid crystal display panel and light sources in the case of an edge-type backlight, and FIG. 6 is an example diagram showing the arrangement of a liquid crystal display panel and light sources in the case of a direct-type backlight.

The liquid crystal display panel 210 may be divided into a plurality of panel blocks as shown in FIGS. 5 and 6. FIGS. 5 and 6 illustrate that the liquid crystal display panel 210 is equally divided into 16 blocks BL1 to BL16, but it should be noted that it is not limited thereto. Each of the plurality of panel blocks may include a plurality of pixels.

The backlight 250 may be implemented as either an edge type or a direct type.

The edge-type backlight 250 has a structure in which a plurality of optical sheets and a light guide plate are stacked below the liquid crystal display panel 210, and a plurality of light sources are disposed on the sides of the light guide plate.

When the backlight 250 is implemented as an edge-type backlight, light sources are disposed on at least one of the upper and lower sides and at least one of the left and right sides of the liquid crystal display panel 210.

In FIG. 5, the first light source array LA1 is disposed on the upper side of the liquid crystal display panel 210, and the second light source array LA2 is disposed on the left side of the liquid crystal display panel 210. Each of the first and second light source arrays LA1 and LA2 includes a plurality of light sources 252 and a light source circuit board 251 on which the plurality of light sources 252 are mounted. In this case, the brightness of the light incident on the first block BL1 of the liquid crystal display panel 210 may be adjusted using the light sources 252A of the first light source array LA1 disposed at a position corresponding to the first block BL1 of the liquid crystal display panel 210 and the light sources 252B of the second light source array LA2.

The direct backlight 250 has a structure in which a plurality of optical sheets and a diffusion plate are stacked below the liquid crystal display panel 210 and a plurality of light sources are arranged below the diffusion plate.

When the backlight 250 is implemented as a direct backlight, it is divided to correspond one-to-one to the blocks BL1 to BL16 of the liquid crystal display panel 210, as shown in FIG. 6. In this case, the brightness of the light incident on the first block BL1 of the liquid crystal display panel 210 may be adjusted using the light sources 252 included in the block B1 of the backlight 250 disposed at a position corresponding to the first block BL1 of the liquid crystal display panel 210.

The light sources 252 may be implemented as point light sources such as light emitting diodes (LEDs). The light sources 252 are turned on and off by receiving a light source driving signal (LDS) from the light source driver 256.

The light source driving signal may be a PWM(Pulse Width Modulation) signal.

The light intensity of the light sources 252 may be adjusted according to the amplitude of the light source driving signal (LDS), and the lighting period may be adjusted according to the pulse width(or duty ratio). The brightness of light output from the light sources 252 may be adjusted according to the light source driving signal (LDS).

The light source driver 256 may generate the light source driving signal (LDS) based on the dimming value of each block input from the backlight dimming controller 510 and output them to the light source 252.

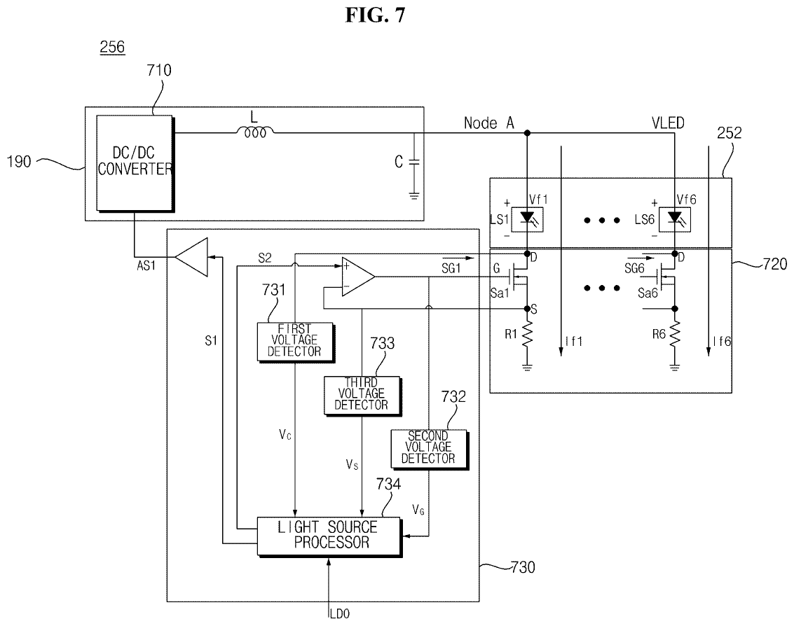

FIG. 7 is an example of a light source driving circuit according to an embodiment of the present disclosure.

The light source driving circuit 256 may include a light source control circuit 720 that drives a plurality of light sources (LS1 to LS6) 252 and a driving signal processor 730 that controls the light source control circuit 720.

The light source driving circuit 256 may receive a power from the power supply circuit 190. The power supply circuit 190 may supply a common power source (VLED) to a plurality of light sources (LS1 to LS6) 252 connected in parallel.

Each of the light sources LS1 to LS6 represents a light source, and each light source may include a plurality of LEDs in series.

Meanwhile, as the resolution of the display device 100 increases to High Definition (HD), Full HD, Ultra High Definition (UHD), 4K, 8K, etc, the number of LEDs may increase.

Meanwhile, when using the high-resolution display panel 210, in order to improve contrast, it is desirable to control the current If with a changed level to flow for each light source based on local dimming data.

According to this, by allowing the level-changed current If to flow in proportion to the local dimming data, a light of different luminance according to the local dimming data is output for each of the plurality of light sources LS1 to LS6.

Accordingly, due to the current If whose level is increased, the luminance of the bright part becomes brighter and the luminance of the dark part becomes darker. Ultimately, the contrast when displaying an image is improved, and the sharpness when displaying an image is improved.

The power supply circuit 190 outputs a common voltage (VLED) to a plurality of light sources. For this purpose, the power supply circuit 190 may include a dc/dc converter 710 for converting the level of a direct current power and outputs it, an inductor (L) for removing harmonics, etc, and a capacitor (C) for storing the direct current power.

The voltage across the capacitor (C) corresponds to the voltage supplied between node A and a ground terminal, which corresponds the voltage applied to a plurality of light sources (LS1 to LS6) 252 and a plurality of switching elements (Sa1 to Sa6), and the resistance elements (R1 to R6). That is, the voltage of node A is the common voltage supplied to the plurality of light sources LS1 to LS6, and may be referred to as the VLED voltage, as shown in the figure.

The VLED voltage is equal to a sum of a driving voltage (Vf1) of a first light source (LS1), a voltage across a first switching element (Sa), and a voltage consumed in a first resistance element (Ra).

Alternatively, the VLED voltage is equal to a sum of a driving voltage (Vf2) of a second light source (LS2), a voltage across a second switching element (Sa2), and a voltage consumed in a second resistance element (Rb). Alternatively, the VLED voltage is equal to a sum of a driving voltage (Vf6) of a sixth light source (LS6), a voltage across a sixth switching element (Sa6), and a voltage consumed in a sixth resistance element (R6).

Meanwhile, as the resolution of the display panel 210 increases, the backlight driving voltage (Vf1 to Vf6) increases and the driving current (If1 to If6) flowing through the backlight also increases.

Meanwhile, the driving signal processor 730 includes a first voltage detector 731 that detects a voltage VD of each drain terminal (G) of the plurality of switching elements (Sa1 to Sa6) implemented with FET, etc.

Meanwhile, the driving signal processor 730 may further include a second voltage detector 732 that detects a voltage (VG) of each gate terminal (G), and a third voltage detector 733 that detects a voltage (VS) of each source terminal(S).

The driving signal processor 730 may compare each drain terminal voltage (VD) detected at each drain terminal (G) of the plurality of switching elements (Sa1 to Sa6), and based on the lowest drain terminal voltage among them, generate a target driving current flowing through the plurality of light sources LS1 to LS6 and output a switching control signal SG corresponding to the generated target driving current.

The switching control signal (SG) is input to the comparator, and when it is greater than the detected voltage (VD) of the source terminal, it is output from the comparator and input to the gate terminal (G). Ultimately, the switching element is driven based on the switching control signal (SG).

Meanwhile, in order to generate this switching control signal, the driving signal processor 730 may include a light source processor 734 that generates a switching control signal for driving each gate terminal of the plurality of switching elements Sa1 to Sa6 based on the voltage of each drain terminal of the plurality of switching elements Sa1 to Sa6.

Meanwhile, the light source processor 734 may vary a amplitude of the switching control signal SG based on a magnitude of the drain terminal voltage VD of each of the plurality of switching elements Sa1 to Sa6.

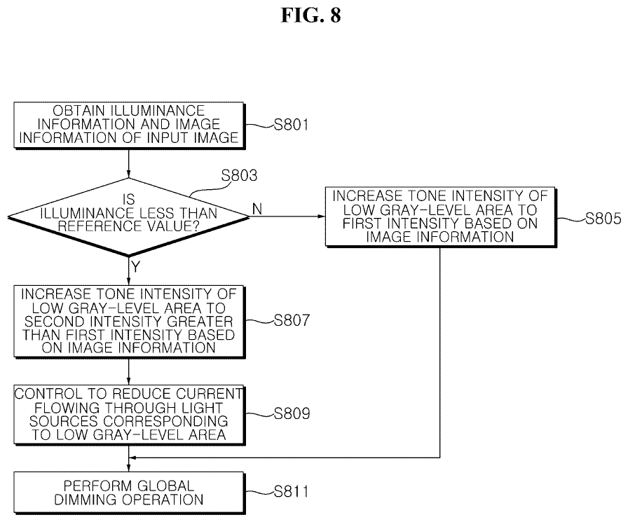

FIG. 8 is a flowchart for explaining a method of operating a display device according to an embodiment of the present disclosure.

Referring to FIG. 8, the controller 170 of the display device 100 may obtain illuminance information and image information of the input image (S801).

In one embodiment, the display device 100 may measure an illuminance through an illuminance sensor provided on one side of the display 180. The illuminance information may include the illuminance.

In another embodiment, the controller 170 may receive the illuminance information from an illuminance sensor disposed adjacent to the display 180.

The image information of the input image may include at least one of a maximum luminance (or peak luminance) of the input image, a minimum luminance, an average picture level (APL), histogram information, information about a low gray-level area, information about a middle gray-level area, information about a high gray-level area, or tone mapping curve information.

The image information of the input image may further include histogram information and a peak luminance of each of a plurality of local areas constituting an entire area of the input image.

The histogram information may be information representing a distribution of the luminance for each pixel of the input image.

The low gray-level area may be a dark area of the input image, the high gray-level area may be a bright area of the input image, and the medium gray-level area may be an area excluding the bright and dark areas of the entire area of the input image.

In one embodiment, the entire area of the input image may be classified into a low gray-level area, a medium gray-level area, and a high gray-level area. For example, the low gray-level area may be an area whose luminance is in the lower 10% range (or lower 5-10% range), the high gray-level area may be an area whose luminance is in the upper 20% range, and the medium gray-level area may be the remaining areas excluding the low gray-level area and the high gray-level area.

In another embodiment, the entire area of the input image may be classified into a low gray-level area and a high gray-level area. For example, the low gray-level area may be an area whose luminance is in the lower 10% range (or lower 5-10% range), and areas other than the low gray-level area may be the high gray-level area. As another example, the low gray-level area may be an area where the luminance value ranges from 1 nit to 10 nits, but this is only an example.

Information about the low gray-level area may include information identifying the low gray-level area of the input image. Information about the low gray-level area may include the luminance and coordinates of each pixel corresponding to the low gray-level area.

Information about the low gray-level area may include information identifying the medium gray-level area of the input image. Information about the medium gray-level area may include the luminance and coordinates of each pixel corresponding to the medium gray-level area.

Information about the high gray-level area may include information identifying the high gray-level area of the input image. Information about the high gray-level area may include the luminance and coordinates of each pixel corresponding to the high gray-level area.

The input image may be an HDR image.

When the input image is the HDR image, the controller 170 may obtain image information of the HDR image through metadata of the HDR image.

Meanwhile, when the input image is an HDR image, the controller 170 may perform HDR processing before applying tone enhancement and dimming, which will be described later, based on illuminance and image information.

The HDR processing may include an Electro-Optical Transfer Function (EOTF) processing, a basic tone mapping, and an Opto-Electrical Transfer Function (OETF) processing.

The EOTF processing may be a process of converting an electrical signal of an HDR image into a brightness signal.

Basic tone mapping may be a process of adjusting a brightness and a contrast ratio of the HDR image according to the maximum luminance range of the display 180 based on the converted brightness signal. The tone enhancement, which will be described later, may be a process of adjusting a slope of the tone mapping curve corresponding to the basic tone mapping.

The OETF processing may be a process of reconverting the brightness signal of the HDR image into an electrical signal after basic tone mapping.

The controller 170 may determine whether the illuminance included in the illuminance information is less than a reference value (S803).

In one embodiment, the reference value may be set as a default or may be a value determined according to user settings.

The controller 170 may determine a viewing environment when the illuminance is above the reference value as a first viewing environment, and may determine the viewing environment when the illuminance is below the reference value as a second viewing environment.

The first viewing environment may be referred to as a bright environment, and the second viewing environment may be referred to as a dark environment.

If it is determined that the illuminance is more than or equal to the reference value, the controller 170 may increase a tone intensity of the low gray-level area to a first intensity based on the image information (S805).

Increasing the tone intensity may mean increasing a ratio of the output level to the input level.

In one embodiment, the tone intensity may be the slope of the tone mapping curve.

In one embodiment, the controller 170 may increase the slope of the basic tone mapping curve corresponding to the low gray-level area to a first slope based on the illuminance being more than or equal to the reference value.

That is, increasing the slope of the tone mapping curve for the low gray-level area to the first slope may mean increasing the tone intensity of the low gray-level area to the first intensity.

When the illuminance is higher than the reference value, the controller 170 may perform tone mapping using a tone mapping curve with the first slope for the low gray-level area.

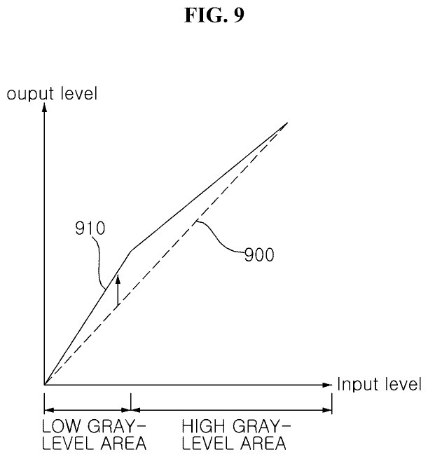

FIG. 9 is a diagram illustrating an example of increasing the slope of a tone mapping curve corresponding to a low gray-level area based on the illuminance being more than or equal to the reference value according to an embodiment of the present disclosure.

Referring to FIG. 9, a tone mapping straight line 900 and a first tone mapping curve 910 are shown showing a 1:1 ratio relationship between the input level (or input gray-level level) and the output level of HDR image data. A default slope of the tone mapping straight line 900 may be 1, but this is only an example.

The controller 170 may perform tone mapping for the low gray-level area using the first tone mapping curve 910 having a first slope greater than the default slope based on the illuminance being more than or equal to the reference value.

The controller 170 may perform tone mapping on the high gray-level area other than the low gray-level area using the tone mapping straight line 900.

Again, FIG. 8 will be described.

If it is determined that the illuminance is less than the reference value, the controller 170 may increase the tone intensity of the low gray-level area to a second intensity greater than the first intensity based on the image information (S807).

In one embodiment, the controller 170 may increase the slope of the tone mapping curve corresponding to the low gray-level area to a second slope greater than the first slope based on the illuminance being less than the reference value.

That is, increasing the slope of the tone mapping curve for the low gray-level area to the second slope may mean increasing the tone intensity of the low gray-level area to the second intensity.

When the illuminance is less than the reference value, the controller 170 may perform tone mapping using a tone mapping curve with the second slope for the low gray-level area.

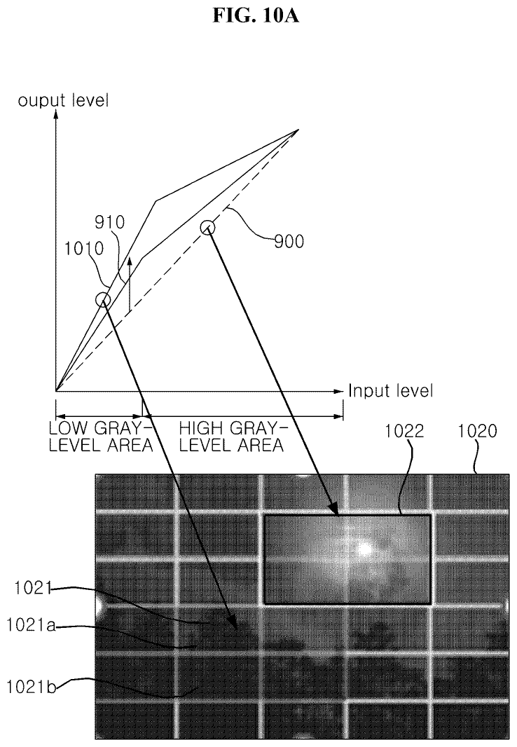

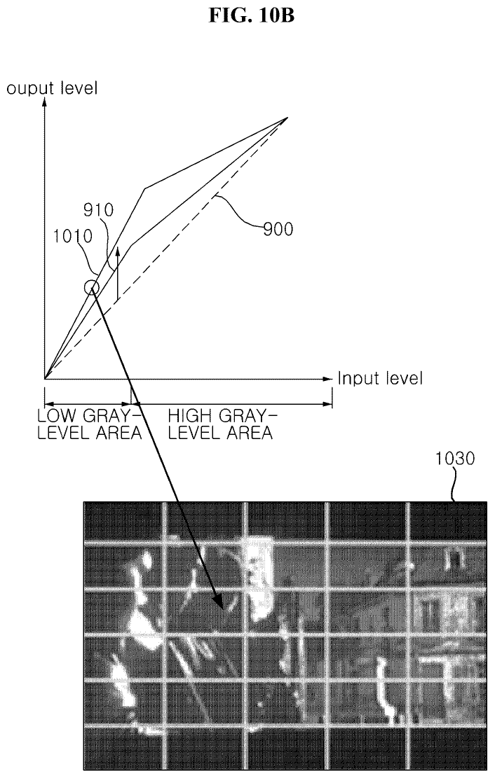

FIGS. 10A and 10B are diagrams illustrating an example of increasing a slope of a tone mapping curve corresponding to a low gray-level area based on a illuminance being less than a reference value according to an embodiment of the present disclosure.

In FIG. 10A, a first HDR image 1020, which is an input image, may include a low gray-level area and a high gray-level area, and a second HDR image 1030 in FIG. 10B may include only a low gray-level area.

Referring to FIGS. 10A and 10B, a tone mapping straight line 900, a first tone mapping curve 910, and a second tone mapping curve 1010 are shown showing the relationship between an input level (or input gray-level) of HDR image data and an output level.

The controller 170 may perform tone mapping for the low gray-level area using the second tone mapping curve 1010 having a second slope greater than the first slope based on the illuminance being less than the reference value.

The second tone mapping curve 1010 may have a greater output level compared to the input level in a low gray-level area than the first tone mapping curve 910. That is, when the illuminance is less than the reference value, the tone intensity for the low gray-level area may be increased.

The controller 170 may perform tone mapping using the tone mapping straight line 900 for the high gray-level area based on the illuminance being less than the reference value.

Referring to FIG. 10A, the first HDR image 1020 may include a low gray-level area 1021 and a high gray-level area 1022. The low gray-level area 1021 may be an area other than the high gray-level area 1022 among an entire area of the first HDR image 1020.

When the illuminance is less than the reference value, the controller 170 may maintain the tone of the high gray-level area 1022 and increase the tone of the low gray-level area 1021.

When the illuminance is less than the reference value, the controller 170 may maintain the tone of the high gray-level area 1022 using the tone mapping straight line 900, and may increase (or strengthen) the tone of the low gray-level area 1021 using the second tone mapping curve 1010.

Accordingly, the expressiveness of the low gray-level area 1021 of the first HDR image 1020 may be improved and the luminance may be secured.

The low gray-level area 1021 may include a plurality of local areas. For example, the low gray-level area 1021 may include a first local area 1021a and a second local area 1021b.

The controller 170 may determine the tone intensity corresponding to each local area based on histogram information and peak luminance of each local area.

For example, the controller 170 may determine the tone intensity of the first local area 1021a as the second intensity according to the histogram and the peak luminance of the first local area 1021a. The controller 170 may determine the tone intensity of the second local area 1021b to be a third intensity greater than the second intensity according to the histogram and the peak luminance of the second local area 1021b.

The third intensity may represent a third slope that is greater than the second slope of the second tone mapping curve 1010. That is, a different local tone mapping curve may be applied to each local area.

In this way, according to the embodiment of the present disclosure, the expressiveness of the image in the low gray-level area of the HDR image may be improved as the tone of each local area of the low gray-level area is locally adjusted.

Referring to FIG. 10B, a second HDR image 1030 may consist of only low gray-level areas. If the illuminance is less than the reference value, the controller 170 may increase the tone of the entire area of the second HDR image 1030. When the illuminance is less than the reference value, the controller 170 may perform tone mapping on the entire area of the second HDR image 1030 using the second tone mapping curve 1010 having the second slope.

Additionally, the controller 170 may divide the entire area of the second HDR image 1030 into a plurality of local areas and adjust the tone intensity of each local area according to the histogram and peak luminance of each local area. That is, a different local tone mapping curve may be applied to each local area.

Again, FIG. 8 will be described.

Thereafter, the controller 170 may control the light source driving circuit 256 to reduce the current flowing through the light sources corresponding to the low gray-level area of the input image (S809).

In one embodiment, the controller 170 may control the light source driving circuit 256 to reduce the current flowing through the light sources included in the backlight 250 corresponding to the location of the low gray-level area of the input image among the plurality of light sources. This is to improve a black visibility in the low gray-level area of the input image.

The controller 170 may control the light source driving circuit 256 to increase the current flowing through the plurality of light sources included in the backlight 250 corresponding to the location of the high gray-level area of the input image.

Decreasing the output brightness of a plurality of light sources may mean applying a dimming, and increasing the output brightness of a plurality of light sources may mean not applying the dimming.

The output brightness of the light source may be adjusted according to the intensity of the current flowing through the light source.

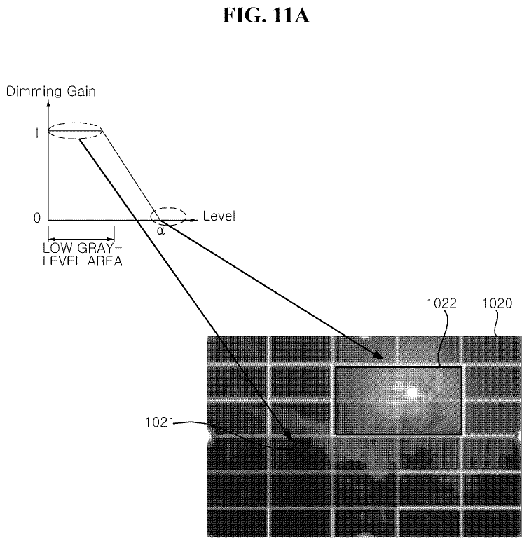

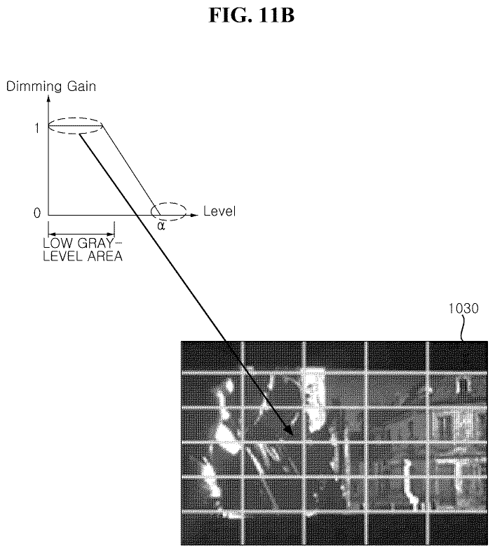

FIGS. 11A and 11B are diagrams illustrating a process of applying dimming after performing tone mapping on a low gray-level area when the illuminance value is less than a reference value according to an embodiment of the present disclosure.

Referring to FIG. 11A, when the illuminance value is less than the reference value, the controller 170 may increase the tone intensity of the low gray-level area 1021 of the first HDR image 1020 to the second intensity in step S807, and then set a dimming gain of a plurality of light sources at positions corresponding to the low gray-level area 1021 to 1. The dimming gain may indicate the output brightness of the light source and may have a value from 0 to 1.

The closer the dimming gain is to 1, the darker the output brightness of the light source may be, and the closer the dimming gain is to 0, the brighter the output brightness of the light source.

The controller 170 may apply dimming to the low gray-level area 1021 of the first HDR image 1020 to improve the black crush(or black visibility) of the low gray-level area 1021.

The controller 170 may not apply dimming to the high gray-level area 1022 in order to maintain the peak luminance of the high gray-level area 1022 of the first HDR image 1020.

In this way, according to the embodiment of the present disclosure, the expressiveness and black visibility for the low gray-level area of the input image may be improved, and the peak luminance for the high gray-level area may be maintained.

Referring to FIG. 11B, when the illuminance value is less than the reference value, the controller 170 may increase the tone intensity of the entire area of the second HDR image 1030 in step S807 and then set the dimming gain of all light sources included in the backlight 250 to 1.

Accordingly, the black visibility of the second HDR image 1030, which consists of only low gray-level areas, may be improved.

Meanwhile, the dimming may be applied to the low gray-level area and the medium gray-level area when the input image is comprised of the low gray-level area, the medium gray-level area, and the high gray-level area.

Again, FIG. 8 will be described.

Afterwards, the controller 170 may control the operation of the backlight 250 to perform a global dimming operation (S811).

The global dimming operation may be an operation that uniformly controls the brightness of an entire screen of the display 180. The controller 170 may control the light source driving circuit 256 to control the brightness of the entire screen.

The controller 170 may control the global dimming operation based on the APL included in the image information of the input image. The controller 170 may control the backlight 250 so that the brightness of the entire screen decreases as the APL of the input image increases, and may control the backlight 250 so that the brightness of the entire screen increases as the APL of the input image decreases.

The controller 170 may control the global dimming operation of the backlight 250 based on the APL and illuminance of the input image.

If the illuminance is less than the reference value and the APL is less than a preset value, the controller 170 may set the dimming gain for the global dimming operation to 1.

If the illuminance is less than the reference value and the APL is more than or equal to a preset value, the controller 170 may set the dimming gain for the global dimming operation to a value of 0.1 or less.

When the illuminance is more than or equal to the reference value and the APL is less than the preset value, the controller 170 may set the dimming gain for the global dimming operation to a value of 0.9 or more.

If the illuminance is more than or equal to than the reference value and the APL is more than or equal to the preset value, the controller 170 may set the dimming gain for the global dimming operation to 0.

After the global dimming operation, the controller 170 may output an output image through the display panel 210.

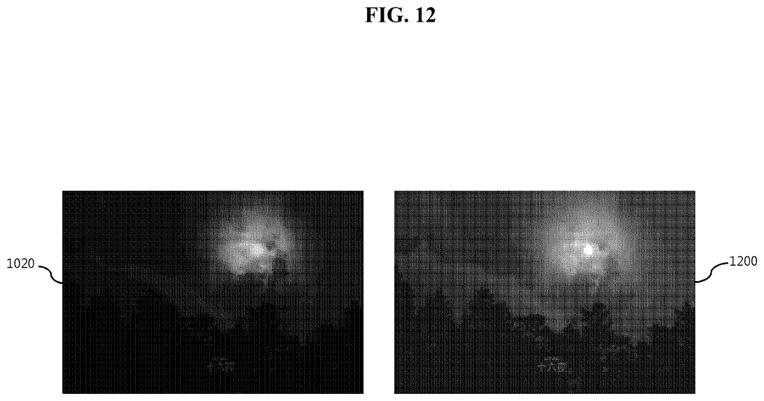

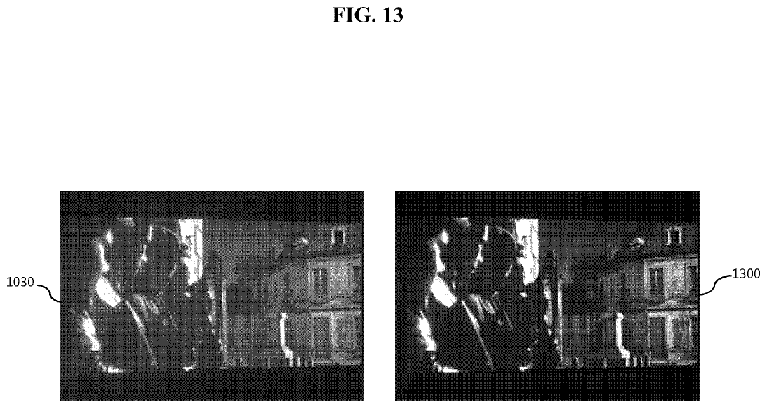

FIGS. 12 and 13 are diagrams comparing before and after applying tone enhancement and dimming to a low gray-level area of an HDR image according to an embodiment of the present disclosure.

Referring to FIG. 12, the first HDR image 1020 may include the low gray-level area and the high gray-level area as shown in FIG. 10A. When tone enhancement and dimming gain 1 are applied to the low gray-level area of the first HDR image 1020 and tone maintenance and dimming gain 0 are applied to the high gray-level area, a first HDR corrected image 1200 may be obtained.

When compared to the first HDR image 1020, the first HDR corrected image 1200 may be confirmed to have improved image expression and black visibility.

Referring to FIG. 13, the second HDR image 1030 may include only the low gray-level area as shown in FIG. 10B. When tone enhancement and dimming gain 1 are applied to the low gray-level area of the second HDR image 1030, a second HDR corrected image 1300 may be obtained.

When compared with the second HDR image 1030, the second HDR corrected image 1300 may be confirmed to have improved image expression and black visibility.

Meanwhile, when the tone enhancement and the dimming are applied to a low gray-level area of an HDR image according to an embodiment of the present disclosure, the actual brightness of the low gray-level area may become dark, and the brightness of the mid-low gray-level area and the high gray-level area may have little effect.

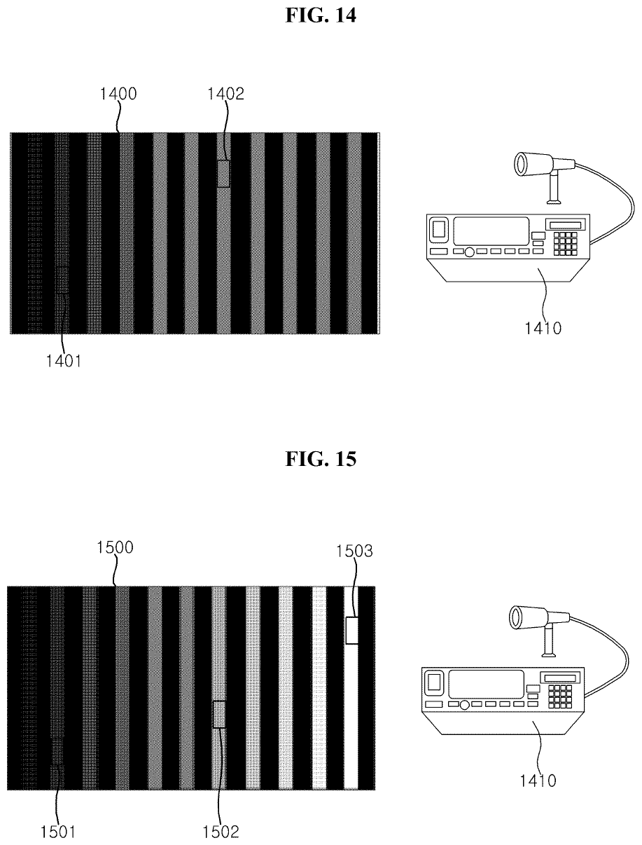

FIGS. 14 and 15 are diagrams illustrating a method for determining whether an embodiment of the present disclosure is applicable.

FIGS. 14 and 15, a HDR image pattern generator may output an HDR image pattern on the display 180.

In FIG. 14, the display 180 is placed in a dark room environment and a bright room environment, and then the luminance of a low gray-level pattern of a first HDR image pattern 1400 output on the display 180 in each environment is measured to determine whether or not the embodiment of the present disclosure is applicable.

The first HDR image pattern 1400 may include only a plurality of low gray-level patterns. Each low gray-level pattern may be a low gray-level clipping pattern.

The dark room environment may be the second viewing environment described in step S803, and the light room environment may be the first viewing environment described in step S803.

If the luminance of each of a first low gray-level pattern 1401 and a second low gray-level pattern 1402 measured through a luminance meter 1410 in a dark room environment compared to a bright room environment is greater, it may be determined that an embodiment of the present disclosure that increases the intensity of the tone in the low gray-level area has been applied.

In FIG. 15, the display 180 is placed in a dark room environment and a bright room environment, and then the luminance of each gray-level pattern of a second HDR image pattern 1500 output on the display 180 in each environment is measured to determine whether or not the embodiment of the present disclosure is applicable.

The second HDR image pattern 1500 may include a low gray-level pattern 1501, a medium gray-level pattern 1502, and a high gray-level pattern 1503. The APL of each pattern may increase toward the low gray-level pattern 1501, the medium gray-level pattern 1502, and the high gray-level pattern 1503.

If the brightness of the low gray-level pattern 1501 or the low gray-level pattern 1501 and the medium gray-level pattern 1503 becomes darker in a dark room environment compared to the bright room environment, and the brightness of the high gray-level pattern 1503 does not darken, it may be determined that the embodiment of the present disclosure, which applies dimming in the low gray-level area or the low gray-level area and the medium gray-level area, has been applied.

A display device 100 according to an embodiment of the present disclosure may comprise a display panel 210; a backlight 250 including a plurality of light sources that provide light to the display panel; and a controller 170 configured to: obtain a illuminance and image information of an input image, increase a tone intensity of a low gray-level area of the input image based on the image information when the illuminance is less than a reference value, and control the backlight so that a current flowing in light sources corresponding to the low gray-level area is reduced.

The controller 170 may, when the illuminance is more than or equal to the reference value, increase the tone intensity of the low gray-level area by a first intensity, and when the illuminance is less than the reference value, increase the tone intensity of the low gray-level area to a second intensity greater than the first intensity.

When the illuminance is more than or equal to the reference value, a slope of a tone mapping curve for tone mapping of the low gray-level area may be a first slope, and when the illuminance is less than the reference value, the slope of the tone mapping curve for tone mapping of the low gray-level area may be a second slope greater than the first slope.

The controller 170 may maintain the tone for a high gray-level area of the input image, and control the backlight 250 to increase the current flowing through light sources corresponding to the high gray-level area.

The low gray-level area may include a plurality of local areas, and the controller 170 may determine the tone intensity for each local area based on histogram information and peak luminance of each local area.

The image information may include at least one of a maximum luminance (or peak luminance), a minimum luminance, an average picture level (APL), histogram information, information about the low gray-level area, information about the middle gray-level area, information about the high gray-level area, or tone mapping curve information of the input image.

When the illuminance is changed from a first viewing situation in which the illuminance is more than or equal to the reference value to a second situation in which the illuminance is less than the reference value, the luminance measured for the low gray-level area may be increased.

The controller 170 may perform a global dimming operation that controls a brightness of a entire screen at once.

The controller 170 may perform the global dimming operation based on the illuminance and an average picture level (APL) of the input image.

The input image may be a HDR(High Dynamic Range) image.

The present disclosure described above may be implemented as computer-readable code on a program-recorded medium. Computer-readable media includes all types of recording devices that store data that may be read by a computer system. Examples of computer-readable media include hard disk drives (HDDs), solid state disks (SSDs), silicon disk drives (SDDs), ROMs, RAMs, CD-ROMs, magnetic tapes, floppy disks, and optical data storage devices. Additionally, the computer may include a controller 170 of the display device 100. Accordingly, the above detailed description should not be construed as restrictive in all respects and should be considered illustrative.

What is claimed is:

1. A display device, comprising:
a display panel;
a backlight including a plurality of light sources that provide light to the display panel; and
a controller configured to:
obtain a illuminance and image information of an input image,
increase a tone intensity of a low gray-level area of the input image based on the image information when the illuminance is less than a reference value, and
control the backlight so that a current flowing in light sources corresponding to the low gray-level area is reduced.

2. The display device of claim 1, wherein the controller is further configured to:
when the illuminance is more than or equal to the reference value, increase the tone intensity of the low gray-level area by a first intensity, and
wherein the controller is configured to:
when the illuminance is less than the reference value, increase the tone intensity of the low gray-level area to a second intensity greater than the first intensity.

3. The display device of claim 1, wherein when the illuminance is more than or equal to the reference value, a slope of a tone mapping curve for tone mapping of the low gray-level area is a first slope, and
when the illuminance is less than the reference value, the slope of the tone mapping curve for tone mapping of the low gray-level area is a second slope greater than the first slope.

4. The display device of claim 1, wherein the controller is further configured to:
maintain the tone for a high gray-level area of the input image, and
control the backlight to increase the current flowing through light sources corresponding to the high gray-level area.

5. The display device of claim 1, wherein the low gray-level area includes a plurality of local areas, and
wherein the controller is further configured to:
determine the tone intensity for each local area based on histogram information and peak luminance of each local area.

6. The display device of claim 1, wherein the image information includes at least one of a maximum luminance (or peak luminance), a minimum luminance, an average picture level (APL), histogram information, information about the low gray-level area, information about the middle gray-level area, information about the high gray-level area, or tone mapping curve information of the input image.

7. The display device of claim 1, wherein when the illuminance is changed from a first viewing situation in which the illuminance is more than or equal to the reference value to a second situation in which the illuminance is less than the reference value, the luminance measured for the low gray-level area is increased.

8. The display device of claim 1, wherein the controller is further configured to:
perform a global dimming operation that controls a brightness of a entire screen at once.

9. The display device of claim 8, wherein the controller is configured to:
perform the global dimming operation based on the illuminance and an average picture level (APL) of the input image.

10. The display device of claim 1, wherein the input image is a HDR(High Dynamic Range) image.

11. A method of operating a display device, comprising:
obtaining a illuminance and image information of an input image;
increasing a tone intensity of a low gray-level area of the input image based on the image information when the illuminance is less than a reference value; and
controlling the backlight so that a current flowing in light sources corresponding to the low gray-level area is reduced.

12. The method of claim 11, further comprising:
when the illuminance is more than or equal to the reference value, increasing the tone intensity of the low gray-level area by a first intensity, and
wherein the increasing a tone intensity of a low gray-level area of the input image based on the image information when the illuminance is less than a reference value comprises:
when the illuminance is less than the reference value, increasing the tone intensity of the low gray-level area to a second intensity greater than the first intensity.

13. The method of claim 11, wherein when the illuminance is more than or equal to the reference value, a slope of a tone mapping curve for tone mapping of the low gray-level area is a first slope, and
when the illuminance is less than the reference value, the slope of the tone mapping curve for tone mapping of the low gray-level area is a second slope greater than the first slope.

14. The method of claim 11, further comprising:
maintaining the tone for a high gray-level area of the input image; and
controlling the backlight to increase the current flowing through light sources corresponding to the high gray-level area.

15. The method of claim 11, wherein the low gray-level area includes a plurality of local areas, and
wherein the method further comprises:
determining the tone intensity for each local area based on histogram information and peak luminance of each local area.

16. The method of claim 11, wherein the image information includes at least one of a maximum luminance (or peak luminance), a minimum luminance, an average picture level (APL), histogram information, information about the low gray-level area, information about the middle gray-level area, information about the high gray-level area, or tone mapping curve information of the input image.

17. The method of claim 11, wherein when the illuminance is changed from a first viewing situation in which the illuminance is more than or equal to the reference value to a second situation in which the illuminance is less than the reference value, the luminance measured for the low gray-level area is increased.

18. The method of claim 11, further comprising:
performing a global dimming operation that controls a brightness of a entire screen at once.

19. The method of claim 18, wherein the performing a global dimming operation comprises:
performing the global dimming operation based on the illuminance and an average picture level (APL) of the input image.

20. A non-transitory computer-readable recording medium on which a program for performing a method of operating a display device is recorded,
wherein the method comprises:
obtaining a illuminance and image information of an input image;
increasing a tone intensity of a low gray-level area of the input image based on the image information when the illuminance is less than a reference value; and
controlling the backlight so that a current flowing in light sources corresponding to the low gray-level area is reduced.
